(19) United States
(12) Patent Application Publication
(10) Pub. No.: US 2025/0012454 A1
(43) Pub. Date: Jan. 9, 2025

(54) SYSTEM HAVING AT LEAST ONE BUILT-IN HOUSEHOLD APPLIANCE AND METHOD FOR ITS OPERATION

(71) Applicant: Miele & Cie. KG, Guetersloh (DE)

(72) Inventors: Thomas METZ, Buende (DE); Christian BOEHM, Vechta (DE); Gunnar BORGELT, Bad Salzuflen (DE)

(21) Appl. No.: 18/761,333

(22) Filed: Jul. 2, 2024

(30) Foreign Application Priority Data
Jul. 4, 2023 (DE) 10 2023 117 594.7

(51) Int. Cl. F24C 15/30; F24C 15/02

(52) U.S. Cl. CPC F24C 15/30; F24C 15/02

(57) ABSTRACT

A system includes: at least one household appliance for installation in a furniture item having a receiving space for the at least one household appliance and a door that is movable back and forth between a closed position and an open position, a receiving space opening of the receiving space with the at least one household appliance completely arranged therein being completely covered by the door in the closed position, and in the open position of the door accessible to the receiving space by a user of the system by the receiving space opening; and a safety device that, in a secured state of the safety device, depending on a presence of at least one previously defined operating state of the at least one household appliance, prevents the door from being transferred into the closed position and/or allows the door to be fully automatically transferred from the closed position.

### CROSS-REFERENCE TO PRIOR APPLICATION

Priority is claimed to German Patent Application No. DE 10 2023 117 594.7, filed on Jul. 4, 2023, the entire disclosure of which is hereby incorporated by reference herein.

### FIELD

The invention relates to a system having at least one household appliance for installation in a furniture item and to a method for operating a system.

### BACKGROUND

A system for installing a household appliance in a furniture item having a receiving space for the at least one household appliance and having a door which can be moved back and forth between a closed position and an open position is known from the publications DE 10 2018 212 045 A1, US 2019 0 178 504 A1, DE 10 2020 105 158 A1 and DE 20 2007 005 524 U1.

### SUMMARY

In an embodiment, the present invention provides a system, comprising: at least one household appliance configured for installation in a furniture item having a receiving space for the at least one household appliance and a door that is movable back and forth between a closed position and an open position, a receiving space opening of the receiving space with the at least one household appliance completely arranged therein being completely covered by the door in the closed position, and in the open position of the door accessible to the receiving space by a user of the system by the receiving space opening; and a safety device configured such that, in a secured state of the safety device, depending on a presence of at least one previously defined operating state of the at least one household appliance, the safety device prevents the door from being transferred into the closed position and/or allows the door to be fully automatically transferred from the closed position towards the open position, wherein the safety device, in the secured state, is configured to mechanically lock the door in an intermediate position of the door between the open position and the closed position, or a door drive of the system for automatically transferring the door from the open position into the closed position is controllable by the safety device in the secured state such that the door is automatically transferrable only from the open position into an intermediate position of the door between the open position and the closed position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an embodiment of the system according to the invention for carrying out the method according to the invention in a partial, sectional side view; and

FIG. 2 shows the embodiment in a partial, detailed view in the region of the power connection box.

### DETAILED DESCRIPTION

In an embodiment, the present invention improves a system having at least one household appliance for installation in a furniture item and a method for operating a system.

In an embodiment, the present invention provides a system that has a safety device, wherein the safety device is designed such that in a secured state of the safety device, depending on the presence of at least one previously defined operating state of the household appliance, the safety device prevents the door from being transferred into its closed position and/or allows the door to be fully automatically transferred from its closed position towards its open position. The safety device is thus automatically transferred into its secured state depending on the presence of the at least one previously defined operating state of the at least one household appliance.

In particular, an advantage achievable by the invention is that a system having at least one household appliance for installation in a furniture item and a method for operating a system are improved. As a result of the design of the system and the method according to the invention, it is possible to balance out the competing requirements of furniture manufacturers on the one hand and of household appliance manufacturers on the other. Furniture manufacturers usually provide that a household appliance built into a furniture item is connected to a power supply by means of a shutdown device. As soon as the door of the system, for example a furniture door of the furniture item, has been transferred into its closed position, the power supply to the household appliance is interrupted fully automatically by means of the aforementioned shutdown device in order to protect the furniture item from moisture and excessive heat, for example. However, such a fully automatic shutdown of the power supply can be disadvantageous for the household appliance built into the furniture item, since, for example, moisture present in the household appliance cannot be discharged to the outside, but condenses in the household appliance itself. In addition, this may also lead to reduced safety of the household appliance and thus to a danger to life and limb of a user of the household appliance. The invention overcomes this problem. By means of the invention, it is now possible to take into account the interests of not only the furniture manufacturers but also of the household appliance manufacturers and to prevent the aforementioned problems.

In principle, the system according to the invention is freely selectable within broad, suitable limits as regards type, mode of operation, material, dimensions and arrangement. For example, the at least one household appliance can be a kitchen appliance, such as a cooking appliance with a cooking chamber, a coffee machine or the like. However, it is also conceivable that the at least one household appliance is designed as a laundry treatment appliance, such as a washing machine, a tumble dryer or a washer-dryer.

An advantageous embodiment of the system according to the invention provides that the safety device is designed and configured in such a way that the safety device, in its secured state, mechanically locks the door in its open position or in an intermediate position of the door between the open position and the closed position, or that a door drive of the system for automatically transferring the door from its open position into its closed position can be controlled by means of the safety device in its secured state in such a way that the door drive is deactivated or the door is automatically transferred only from the open position into an intermediate position of the door between the open position and the closed position. In this way, on the one hand, an embodiment of the system according to the invention is specified which is suitably designed for a system with a manually movable door. On the other hand, an alternative embodiment of the system according to the invention is provided in which the door is suitably designed to be movable automatically, i.e. semi-automatically and/or fully automatically. A person skilled in the art will select the appropriate embodiment depending on the requirements of the individual case.

Accordingly, an advantageous embodiment of the method according to the invention provides that the safety device, in its secured state, mechanically locks the door in its open position or in an intermediate position of the door between the open position and the closed position, or that a door drive of the system for automatically transferring the door from its open position into its closed position is controlled by means of the safety device in its secured state in such a way that the door drive is deactivated or the door is automatically transferred only from the open position into an intermediate position of the door between the open position and the closed position.

A further advantageous embodiment of the system according to the invention provides that the safety device is designed and configured in such a way that a door drive of the system for automatically transferring the door from its closed position into its open position or into an intermediate position of the door between the open position and the closed position can be fully automatically controlled by means of the safety device in its secured state for the aforementioned transfer of the door into its open position or intermediate position. In addition to or as an alternative to the aforementioned embodiment of the system according to the invention, an embodiment of the system according to the invention is hereby specified in which, depending on the presence of the secured state, the door can be fully automatically transferred from its closed position into its open position or intermediate position.

Accordingly, an advantageous embodiment of the method according to the invention provides that a door drive of the system for automatically transferring the door from its closed position into its open position or into an intermediate position of the door between the open position and the closed position is fully automatically controlled by means of the safety device in its secured state for the aforementioned transfer of the door into its open position or intermediate position.

A further advantageous embodiment of the system according to the invention provides that the aforementioned at least one operating state of the household appliance takes the form of a fan operation of a fan of the household appliance and/or of a heating operation of a heater of the household appliance. In this way, two operating states of the household appliance which are particularly relevant for a household appliance and very important for the aforementioned conflict of interest are specified.

A further advantageous embodiment of the system according to the invention provides that the safety device and the household appliance each have a communication interface and a communication path connecting the two communication interfaces in a signal-transmitting manner for wireless or wired communication with one another for the purpose of a fully automatic transfer of the safety device from a rest state of the safety device, in which the door can be moved back and forth unhindered between its open position and its closed position, into its secured state by detecting the presence of the at least one previously defined operating state of the household appliance, wherein the communication interfaces and the communication path are preferably designed to be tamperproof in such a way that any influence from the outside on this communication is prevented. This makes possible a bidirectional communication between the at least one household appliance and the safety device to determine the presence of the at least one previously defined operating state of the at least one household appliance and thus the presence of the secured state of the safety device. An additional sensor system of the safety device for sensing the at least one previously defined operating state of the at least one household appliance is therefore not required.

An embodiment of the system according to the invention alternative to the aforementioned embodiment provides that the safety device has an operating state detection device for the purpose of fully automatic transfer of the safety device from a rest state of the safety device, in which the door can be moved back and forth unhindered between its open position and its closed position, into its secured state by detecting the presence of the at least one previously defined operating state of the at least one household appliance, wherein by means of the operating state detection device it is at least possible to detect whether at least one of the at least one operating states is present in the household appliance, wherein the presence of a specific operating state of the household appliance can preferably be detected by means of the operating state detection device. In this way, it is possible to equip the system according to the invention with an effective and functionally reliable safety device without a special adaptation of the at least one household appliance to the system according to the invention, since bidirectional communication between the at least one household appliance on the one hand and the safety device on the other is not required. The security against manipulation of the system according to the invention is thus significantly improved in a simple manner in terms of design, manufacture and circuitry. The preferred embodiment of this development also has the further advantage that the secured state of the safety device can be designed depending on the presence of the respective specific operating state of the household appliance.

Accordingly, an advantageous embodiment of the method according to the invention provides that the safety device has an operating state detection device for the purpose of fully automatic transfer of the safety device from a rest state of the safety device, in which the door can be moved back and forth unhindered between its open position and its closed position or is moved back and forth automatically, into its secured state by detecting the presence of the at least one previously defined operating state of the at least one household appliance, wherein by means of the operating state detection device it is at least detected whether at least one of the at least one operating states is present in the household appliance, wherein the presence of a specific operating state of the household appliance can preferably be detected by means of the operating state detection device.

An advantageous embodiment of the last-mentioned embodiment of the system according to the invention provides that the operating state detection device is designed and configured in such a way that at least one of the following measurements can be carried out by means of the operating state detection device: power and/or current measurement at a power supply of the at least one household appliance, wherein the power and/or current measurement of a plurality of household appliances preferably take place independently of one another, and/or the power and/or current measurement is designed as safety electronics; temperature measurement at the at least one household appliance; humidity measurement at the at least one household appliance; air flow measurement at the at least one household appliance; vibration measurement at the at least one household appliance; brightness measurement at a display unit of the at least one household appliance; text recognition at a display unit of the at least one household appliance. This specifies a large number of measurable physical quantities which are characteristic of essential operating states of a household appliance, so that by means of the at least one aforementioned measurement a reliable conclusion can be drawn regarding the presence of the at least one previously defined operating state of the at least one household appliance. For example, in a power measurement, a power consumption of the at least one household appliance of less than 2 W can be classified as unproblematic for a door in the closed position and a power consumption of the at least one household appliance of more than 10 W can prevent the door from being transferred into its closed position, wherein a maximum power consumption per household appliance can be limited to less than or equal to 3.6 kW.

Accordingly, an advantageous embodiment of the method according to the invention provides that the operating state detection device carries out at least one of the following measurements: power and/or current measurement at a power supply of the at least one household appliance, wherein the power and/or current measurement of a plurality of household appliances preferably take place independently of one another, and/or the power and/or current measurement takes the form of safety electronics; temperature measurement at the at least one household appliance; humidity measurement at the at least one household appliance; air flow measurement at the at least one household appliance; vibration measurement at the at least one household appliance; brightness measurement at a display unit of the at least one household appliance; text recognition at a display unit of the at least one household appliance.

Another advantageous embodiment of the system according to the invention provides that the system has a power connection box for supplying power to the at least one household appliance, preferably that the power connection box additionally has a power supply for a door drive of the door for automatically moving the door, particularly preferably that the door drive can be operated by means of safety extra-low voltage. In this way, the power supply of at least one household appliance can be implemented in a particularly simple manner in terms of design and production. For example, if there are a number of household appliances, several of the household appliances may be connected to a common phase of the power supply. However, the household appliances can also be connected to different phases of the power supply. The preferred embodiment of this development has the additional advantage that no separate power connection box or the like is required for the door drive. Instead, the power supply of the door drive can be taken from the power supply of one of the at least one household appliances in a manner known per se to a person skilled in the art. The particularly preferred embodiment of this development has the additional advantage that the safety of the door drive is further improved in that touching live parts of the door drive is not dangerous for a user of the system.

An advantageous embodiment of the last-mentioned development of the system according to the invention provides that the power connection box is simultaneously designed as part of the operating state detection device, preferably that the power connection box is designed for the aforementioned power and/or current measurement of the at least one household appliance. As a result, the operating state detection device can be implemented in a particularly simple manner in terms of design, manufacture and circuitry. This applies in particular to the preferred embodiment of this development. For example, the power and/or current of a plurality of household appliances of the at least one household appliance can be measured independently of one another by means of this development. Furthermore, the at least one household appliance can be electrically connected to the power connection box by means of a country-neutral intermediate cable, while the power connection box can be electrically connected to an external power supply, i.e. a building network, by means of a country-specific power cable.

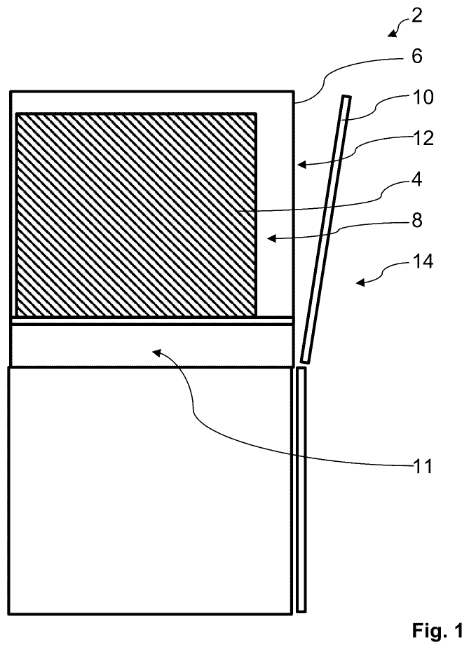

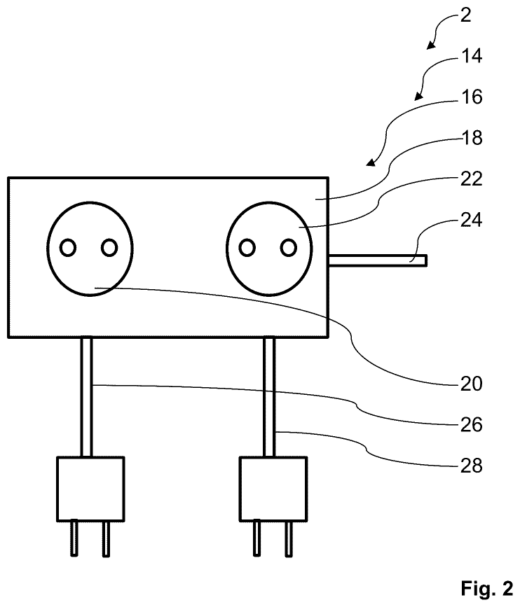

FIGS. 1 and 2 show a purely exemplary embodiment of the system according to the invention for carrying out the method according to the invention.

The system 2 comprises a household appliance 4 designed as a cooking appliance with a cooking chamber for installation in a furniture item 6 having a receiving space 8 for the household appliance 4 and a door 10 which can be moved back and forth between a closed position and an open position, wherein a receiving space opening 12 of the receiving space 8 with the household appliance 4 completely arranged therein is completely covered by the door 10 in the closed position of the door 10 and in the open position of the door 10 access to the receiving space 8 by a user of the system 2 is made possible by means of the receiving space opening 12.

According to the invention, the system 2 has a safety device 14, wherein the safety device 14 is designed such that in a secured state of the safety device 14 shown in FIG. 1, depending on the presence of at least one previously defined operating state of the household appliance 4, the safety device 14 prevents the door 10 from being transferred into its closed position and allows a fully automatic transfer of the door 10 from its closed position towards its open position. In the present embodiment, the door 10 is designed as a so-called pocket door of the furniture item 6, wherein the door 10 can essentially be stowed in a receptacle 11 for the door 10 when the door 10 is open. However, embodiments are also conceivable in which the door is designed, for example, as a combination door consisting of a furniture door and a household appliance door mechanically connected to the furniture door. In the closed position of the door 10, the door 10 extends in the image plane of FIG. 1 substantially parallel to the vertical. In the open position of the door 10, the door 10 extends in the image plane of FIG. 1 substantially parallel to the horizontal.

The safety device 14 is designed and configured such that the safety device 14, in its secured state, mechanically locks the door 10 in an intermediate position of the door 10 between the open position and the closed position, or that a door drive of the system 2 for automatically transferring the door 10 from its open position into its closed position can be controlled by means of the safety device 14 in its secured state in such a way that the door drive is deactivated or the door 10 is automatically transferred only from the open position into the intermediate position of the door 10 between the open position and the closed position. The aforementioned intermediate position is shown in FIG. 1.

Furthermore, the safety device 14 is designed and configured such that the door drive of the system 2 for automatically transferring the door 10 from its closed position into its open position or into the intermediate position of the door 10 between the open position and the closed position can be fully automatically controlled by means of the safety device 14 in its secured state for the aforementioned transfer of the door 10 into its open position or intermediate position.

The aforementioned at least one operating state of the household appliance 4 here takes the form of a fan operation of a fan of the household appliance 4 and of a heating operation of a heater of the household appliance 4.

A first variant of the system according to the invention according to the present embodiment provides that the safety device 14 and the household appliance 4 each have a communication interface and a communication path connecting the two communication interfaces in a signal-transmitting manner for wireless or wired communication with one another for the purpose of fully automatic transfer of the safety device 14 from a rest state of the safety device 14, in which the door 10 can be moved back and forth unhindered between its open position and its closed position, into its secured state by detecting the presence of the at least one previously defined operating state of the household appliance 4, wherein the communication interfaces and the communication path are designed to be tamperproof in such a way that any influence on this communication from the outside is prevented.

Alternatively, a second variant of the system according to the invention according to the present embodiment provides that the safety device 14 has an operating state detection device 16 for the purpose of fully automatic transfer of the safety device 14 from the rest state of the safety device 14, in which the door 10 can be moved back and forth unhindered between its open position and its closed position, into its secured state by detecting the presence of the at least one previously defined operating state of the household appliance 4, wherein by means of the operating state detection device 16 it is at least possible to detect whether at least one of the at least one operating states is present in the household appliance 4. The operating state detection device 16 is shown only in FIG. 2. However, it is also conceivable that in other embodiments of the system according to the invention the presence of a specific operating state of the household appliance can be detected by means of the operating state detection device.

In the present exemplary embodiment, it is provided that the operating state detection device 16 is designed and configured such that at least one of the following measurements can be carried out by means of the operating state detection device 16: power and/or current measurement at a power supply of the at least one household appliance 4, wherein the power and/or current measurement of a plurality of household appliances preferably take place independently of one another, and/or the power and/or current measurement takes the form of safety electronics; temperature measurement at the at least one household appliance; humidity measurement at the at least one household appliance; air flow measurement at the at least one household appliance; vibration measurement at the at least one household appliance; brightness measurement at a display unit of the at least one household appliance; text recognition at a display unit of the at least one household appliance.

For this purpose, the system 2 has a power connection box 18 for supplying power to the household appliance 4, wherein the power connection box 18 is designed to automatically move the door 10 in addition to supplying power to the door drive of the door 10. In the present exemplary embodiment, the door drive can be operated by means of safety extra-low voltage. The power connection box 18 has a total of two sockets 20, 22 for the electrical connection of at least two household appliances, here the household appliance 4, to the power connection box 18. For the aforementioned electrical connection of the household appliance 4 to the power connection box 18, a country-neutral power cable can be used, for example. This power cable is therefore the same for all countries to which the system 2 is delivered. The power supply of the door drive is implemented here in such a way that the electrical connection 24 of the power connection box 18 to the door drive of the power supply for the household appliance 4 is taken from within the power connection box 18 in a manner known per se to a person skilled in the art. The two sockets 20, 22 of the power connection box 18 can be electrically connected to an external power supply, namely the building power supply, by means of country-specific power cables 26, 28. The aforementioned power cables 26, 28 are therefore matched to the country to which the system 2 is delivered. The power connection box 18 is arranged outside a housing of the furniture item 6, namely the receptacle 11 for the door 10 designed as a so-called pocket door. The power connection box 18 can, for example, be arranged in a base of the furniture item 6.

In accordance with the second variant of the present exemplary embodiment, the power connection box 18 is simultaneously designed as part of the operating state detection device 16, wherein the power connection box 18 is designed, for example, to be suitable for the aforementioned power and/or current measurement of the household appliance 4.

The functioning of the system according to the invention and the method according to the invention according to the present embodiment are explained in more detail below with reference to FIGS. 1 and 2.

According to the method according to the invention according to the present exemplary embodiment, it is provided that in the secured state of the safety device 14, depending on the presence of the at least one previously defined operating state of the household appliance 4, the safety device 14 prevents the door 10 from being transferred into its closed position and/or allows the door 10 to be fully automatically transferred from its closed position towards its open position. Accordingly, depending on the embodiment, the present exemplary embodiment is suitable on the one hand for a manually movable door 10 and/or on the other for a fully automatically movable door 10.

Accordingly, the safety device 14, in its secured state, mechanically locks the door 10 in its open position or in the intermediate position of the door 10 between the open position and the closed position, or the door drive of the system 2 for automatically transferring the door 10 from its open position into its closed position is controlled by means of the safety device 14 in its secured state such that the door drive is deactivated or the door 10 is automatically transferred only from the open position into the intermediate position of the door 10 between the open position and the closed position.

Furthermore, the door drive of the system 2 for automatically transferring the door 10 from its closed position into its open position or into the intermediate position of the door 10 between the open position and the closed position, if present, is fully automatically controlled by means of the safety device 14 in its secured state for the aforementioned transfer of the door 10 into its open position or intermediate position.

For the purpose of fully automatic transfer of the safety device 14 from the rest state of the safety device 14, in which the door 10 can be moved back and forth unhindered between its open position and its closed position, into its secured state by detecting the presence of the at least one previously defined operating state of the household appliance 4, the safety device 14 according to the second variant of the system 2 comprises the operating state detection device 16, wherein by means of the operating state detection device 16 it is at least detected whether at least one of the at least one operating states is present in the household appliance 4. In other embodiments of the invention, it can be provided that the presence of a specific operating state of the household appliance is detected by means of the operating state detection device.

For this purpose, at least one of the following measurements is carried out by means of the operating state detection device 16: power and/or current measurement at a power supply of the at least one household appliance 4, wherein the power and/or current measurement of a plurality of household appliances preferably take place independently of one another, and/or the power and/or current measurement is designed as safety electronics; temperature measurement at the at least one household appliance; humidity measurement at the at least one household appliance; air flow measurement at the at least one household appliance; vibration measurement at the at least one household appliance; brightness measurement at a display unit of the at least one household appliance; text recognition at a display unit of the at least one household appliance.

Irrespective of the variant used of the exemplary embodiment, the door 10, namely the door 10 designed as a pocket door, is prevented from being closed even though the household appliance 4 is in at least one of the aforementioned operating states. This applies to the motor-operated embodiment as well as to the manually operated embodiment of the present exemplary embodiment. In the motor-operated embodiment, it is sufficient not to control the door drive. In the manually operated embodiment, the door 10 is locked either in its open position or in its intermediate position and is only fully automatically released when the household appliance 4 no longer poses a danger to the household appliance 4, to the furniture item 6 and in particular to the user of the system 2.

The door 10 is fully automatically opened when the household appliance 4 behind the door 10 in the closed position becomes active, i.e. is transferred into one of the aforementioned operating states. This can be done by remotely starting the household appliance 4 and/or by setting a preset start time for transferring the household appliance 4 into one of the aforementioned operating states.

For this purpose, the safety device 14 must know the appliance status of the household appliance 4, i.e. the presence of at least one of the aforementioned operating states of the household appliance 4. In the first variant of the exemplary embodiment, this is done by means of wireless or wired information transmission between the household appliance 4 and the safety device 14. Communication is bidirectional and takes place via WLAN, Bluetooth or a data cable, for example. The safety device 14 asks the household appliance 4 whether the door 10 can be closed. Depending on the presence of at least one of the aforementioned operating states of the household appliance 4, the household appliance 4 refuses the release. Otherwise, i.e. if none of the aforementioned operating states of the household appliance 4 is present, the release is granted by the household appliance 4. If the household appliance 4 is in a so-called standby state, it is first woken from this standby state in a manner known to a person skilled in the art in order to respond to the request of the safety device 14. This standby state is also referred to as network standby. Closing the door 10 without the aforementioned release of the household appliance 4 is not provided for in the present embodiment. Before the household appliance 4 becomes active behind the closed door 10, it sends the safety device 14 a command to open the door 10. If the safety device 14 does not positively confirm this command, i.e. if the safety device 14 is not in its idle state but in its secured state, the household appliance 4 will not be activated, namely will not be transferred into one of the aforementioned operating states of the household appliance 4. Communication here takes place via a secure connection that cannot be hacked.

In the second variant of the exemplary embodiment, the determination that one of the aforementioned operating states of the household appliance 4 is present is made by means of the measurement at the household appliance 4 explained above. This measurement is, for example, a power or current measurement at the household appliance 4. The following applies here: the household appliance 4 in the aforementioned standby mode, with a power consumption of less than 2 W, poses no danger to the household appliance 4, to the furniture item 6 or to the user of the system 2. If the power consumption is between 10 W, for example when the fan of the household appliance 4 is running, and 3.6 kW, for example when a cooking process is in progress with the heater of the household appliance 4 switched on, the household appliance 4 is considered active, the safety device 14 is automatically transferred into its secured state and the safety device 14 prevents the door 10 from closing.

Alternatively or in addition to the aforementioned power and/or current measurement, it is conceivable that the temperature and/or the humidity and/or an air flow and/or a vibration are measured at the household appliance 4. Furthermore, alternatively or additionally, a display content of a display of the household appliance 4 can be optically evaluated. This can be done, for example, by means of a simple brightness sensor or a camera for text recognition.

If the household appliance 4 becomes active behind the closed door 10, i.e. if at least one of the aforementioned operating states of the household appliance 4 is present, this can also be determined, for example, via the aforementioned power measurement. The door 10 is then fully automatically opened by means of the door drive, i.e. moved into its intermediate position or into its opening position. For this purpose, the safety device 14 can continuously measure the power consumption when the door 10 is closed. However, it is also conceivable that the safety device 14, analogously to the household appliance 4, is in a so-called standby state, wherein the safety device 14 is then woken from this standby state by the flow of current to the household appliance 4. If something prevents the door 10 from opening fully automatically, it can be provided that the household appliance 4 is switched off before there is a danger to the household appliance 4, to the furniture item 6 or to the user of the system 2.

As a result of the design of the system 2 and the method for operating the system 2 according to the invention, it is possible to balance competing requirements of furniture manufacturers for the furniture item 6 on the one hand and of household appliance manufacturers for the household appliance 4 on the other. Furniture manufacturers usually provide that a household appliance built into a furniture item is connected to a power supply by means of a shutdown device. As soon as the door of the system, for example a furniture door of the furniture item, has been transferred into its closed position, the power supply to the household appliance is interrupted fully automatically by means of the aforementioned shutdown device in order to protect the furniture item from moisture and excessive heat, for example. However, such a fully automatic shutdown of the power supply can be disadvantageous for the household appliance 4 built into the furniture item 6, since, for example, moisture present in the household appliance 4 cannot be discharged to the outside, but condenses in the household appliance 4 itself. In addition, this may also lead to reduced safety of the household appliance 4 and thus to a danger to life and limb of the user of the household appliance 4. The invention according to the present embodiment overcomes this problem. By means of the system 2 and the method for operating the system 2, it is now possible to take into account the interests not only of the furniture manufacturers but also of the household appliance manufacturers and to prevent the aforementioned problems.

The invention is not limited to the present exemplary embodiment. See, for example, the relevant statements in the introduction as well as the optional features, embodiments and variants mentioned in the description of the specific embodiment. For example, a plurality of household appliances can also be arranged in the furniture item, wherein the above statements regarding the exemplary embodiment apply analogously to such embodiments of the invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A system, comprising:
at least one household appliance configured for installation in a furniture item having a receiving space for the at least one household appliance and a door that is movable back and forth between a closed position and an open position, a receiving space opening of the receiving space with the at least one household appliance completely arranged therein being completely covered by the door in the closed position, and in the open position of the door accessible to the receiving space by a user of the system by the receiving space opening; and
a safety device configured such that, in a secured state of the safety device, depending on a presence of at least one previously defined operating state of the at least one household appliance, the safety device prevents the door from being transferred into the closed position and/or allows the door to be fully automatically transferred from the closed position towards the open position,
wherein the safety device, in the secured state, is configured to mechanically lock the door in an intermediate position of the door between the open position and the closed position, or a door drive of the system for automatically transferring the door from the open position into the closed position is controllable by the safety device in the secured state such that the door is automatically transferrable only from the open position into an intermediate position of the door between the open position and the closed position.

2. The system of claim 1, wherein the safety device is configured such that a door drive of the system for automatically transferring the door from the closed position into the open position or into an intermediate position of the door between the open position and the closed position is fully automatically controllable by the safety device in the secured state for the transfer of the door into the open position or intermediate position.

3. The system of claim 1, wherein the at least one operating state of the at least one household appliance comprises a fan operation of a fan of the at least one household appliance and/or a heating operation of a heater of the at least one household appliance.

4. The system of claim 1, wherein the safety device and the at least one household appliance each have a communication interface and a communication path connecting the two communication interfaces in a signal-transmitting manner for wireless or wired communication with one another for fully automatic transfer of the safety device from a rest state of the safety device, in which the door is movable back and forth unhindered between the open position and the closed position, into the secured state by detecting the presence of the at least one previously defined operating state of the at least one household appliance.

5. The system of claim 1, wherein the safety device has an operating state detection device for fully automatic transfer of the safety device from a rest state of the safety device, in which the door is movable back and forth unhindered between the open position and the closed position, into the secured state by detecting the presence of the at least one predetermined operating state of the at least one household appliance, and
wherein the operating state detection device is configured to detect whether at least one of the at least one operating states is present in the at least one household appliance.

6. The system of claim 5, wherein the operating state detection device is configured to perform, by the operating state detection device, at least one of:
power and/or current measurement at a power supply of the at least one household appliance;
temperature measurement at the at least one household appliance;
humidity measurement at the at least one household appliance;
air flow measurement at the at least one household appliance;
vibration measurement at the at least one household appliance;
brightness measurement at a display unit of the at least one household appliance; and/or
text recognition at a display unit of the at least one household appliance.

7. The system of claim 1, further comprising:
a power connection box configured to supply power to the at least one household appliance.

8. The system of claim 7, wherein the power connection box simultaneously comprises a part of the operating state detection device.

9. A method for operating the system of claim 1, comprising:
in the secured state of the safety device, depending on the presence of at least one previously defined operating state of the at least one household appliance, the safety device preventing the door from being transferred into the closed position and/or allowing the door to be fully automatically transferred from the closed position towards the open position.

10. The method of claim 9, wherein the safety device, in the secured state, mechanically locks the door in the open position or in an intermediate position of the door between the open position and the closed position, or
wherein a door drive of the system for automatic transfer of the door from the open position into the closed position is controlled by the safety device in the secured state such that the door drive is deactivated or the door is automatically transferred only from the open position into an intermediate position of the door between the open position and the closed position.

11. The method of claim 9, wherein a door drive of the system for automatic transfer of the door from the closed position into the open position or into an intermediate position of the door between the open position and the closed position is fully automatically controlled by the safety device in the secured state for the transfer of the door into the open position or intermediate position.

12. The method of claim 9, wherein the safety device has an operating state detection device for fully automatic transfer of the safety device from a rest state of the safety device, in which the door is movable back and forth unhindered between the open position and the closed position or is movable back and forth automatically, into the secured state by detecting the presence of the at least one predetermined operating state of the at least one household appliance, and
wherein by the operating state detection device it is at least detected whether at least one of the at least one operating states is present in the at least one household appliance.

13. The method of claim 12, wherein the operating state detection device carries out at least one of:
power and/or current measurement at a power supply of the at least one household appliance;
temperature measurement at the at least one household appliance;
humidity measurement at the at least one household appliance;
air flow measurement at the at least one household appliance;
vibration measurement at the at least one household appliance;
brightness measurement at a display unit of the at least one household appliance; and/or
text recognition at a display unit of the at least one household appliance.

14. The system of claim 4, wherein the communication interfaces and the communication path are tamperproof so as to prevent any influence on communication from outside.

15. The system of claim 5, wherein the presence of a specific operating state of the at least one household appliance is detectable by the operating state detection device.

16. The system of claim 6, wherein the power and/or current measurement of a plurality of household appliances take place independently of one another, and/or the power and/or current measurement comprises safety electronics.

17. The system of claim 7, wherein the power connection box is configured to automatically move the door in addition to supply power to a door drive of the door.

18. The system of claim 17, wherein the door drive is operable by safety extra-low voltage.

19. The system of claim 8, wherein the power connection box is configured for the power and/or current measurement of the at least one household appliance.

20. The method of claim 12, wherein the presence of a specific operating state of the at least one household appliance is detected by the operating state detection device.
